(19) United States
(12) Patent Application Publication
(10) Pub. No.: US 2004/0211854 A1
(43) Pub. Date: Oct. 28, 2004

(54) Buckle retainer for a tape cartridge

(76) Inventor: Stephen Stamm, Fort Lupton, CO (US)

Correspondence Address: Hugh H. Matsubayashi, Morrison & Foerster LLP, 755 Page Mill Road, Palo Alto, CA, 94304-1018, US

(21) Appl. No.: 10/422,402

(22) Filed: Apr. 23, 2003

(51) Int. Cl. G11B 23/107

(52) U.S. Cl. 242/348.2

(57) ABSTRACT

A tape cartridge system and a method of operating a tape cartridge system are provided. The tape cartridge system includes a cartridge housing, a reel provided in the cartridge housing, a magnetic tape wound about the reel, a cartridge buckle assembly provided at one end of the magnetic tape, and a buckle retainer provided in the cartridge housing having at least one clamping member for releasably retaining the cartridge buckle assembly. The method includes rotating a reel in a tape cartridge to wind a magnetic tape around the reel until a cartridge buckle assembly provided at one end of the magnetic tape contacts a buckle retainer provided in the tape cartridge, and coupling the cartridge buckle assembly with the buckle retainer by continuing to rotate the reel until the cartridge buckle assembly is releasably retained by the buckle retainer.

### BACKGROUND OF THE INVENTION

Tape drives are widely used for storing information in digital form. An exemplary tape drive system 100 is shown in FIG. 1. These tape drive systems 100 commonly use a storage tape 126 having a thin film of magnetic material which receives the information. Typically, the storage tape is moved between a pair of spaced apart reels 117 and 124, past a data transducer 116 to record or read back information from the storage tape 126.

In one type of tape drive system, one of the reels 117 is part of a tape drive 112 while the other reel 124 is part of a removable tape cartridge 114. For this type of tape drive system 100, the reel 117 which is a part of the tape drive 112 is commonly referred to as a take-up reel 117, while the reel 124 which is a part of the tape cartridge 114 is commonly referred to as a cartridge reel 124. With this system 100, upon insertion of the cartridge 114 into the tape drive 112, the storage tape 126 on the cartridge reel 124 is coupled to the take-up reel 117 of the tape drive 112. Subsequently, prior to removing the tape cartridge 114 from the tape drive 112, the storage tape 126 is rewound onto the cartridge reel 124 and is then uncoupled from the take-up reel 117.

Due to the precise mechanical nature of coupling and uncoupling of the magnetic tape 126 from the take-up reel 117, errors can sometimes occur when the various coupling components are out of place. These errors can be the result of, for example, excessive or insufficient winding of the storage tape 126 around the cartridge reel 124, which can be caused by jostling of the tape cartridge 114. It, is desirable to provide a tape drive system where the tape cartridge 114 can be reliably coupled with the tape drive 112.

### BRIEF SUMMARY OF THE INVENTION

In accordance with embodiments of the present invention, a tape cartridge system is provided. The tape cartridge system comprises a cartridge housing, a reel provided in the cartridge housing, a magnetic tape wound about the reel, a cartridge buckle assembly provided at one end of the magnetic tape, and a buckle retainer provided in the cartridge housing having at least one clamping member for releasably retaining the cartridge buckle assembly.

In accordance with other embodiments of the present invention, a method of operating a tape cartridge system is provided. The method comprises rotating a reel in a tape cartridge to wind a magnetic tape around the reel until a cartridge buckle assembly provided at one end of the magnetic tape contacts a buckle retainer provided in the tape cartridge, and coupling the cartridge buckle assembly with the buckle retainer by continuing to rotate the reel until the cartridge buckle assembly is releasably retained by the buckle retainer.

In accordance with other embodiments of the present invention, a buckle retainer for use in a tape cartridge having a cartridge housing, a magnetic tape wound about a cartridge reel provided in the cartridge housing, and a cartridge buckle assembly provided at one end of the magnetic tape. The buckle retainer comprises a mounting portion for mounting the buckle retainer in the cartridge housing; and a clamping member having at least one flexible flange for releasably retaining the cartridge buckle assembly.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE SEVERAL VIEWS OF THE DRAWING(S)

FIG. 1 is a tape drive system in accordance with embodiments of the present invention.

FIGS. 2A-2B are perspective views of a cartridge leader and a take-up leader in accordance with embodiments of the present invention.

FIGS. 3A-3C are side views of a cartridge buckle assembly.

FIG. 4 is a perspective view of a buckle retainer in accordance with embodiments of the present invention.

FIGS. 5A-5B are-front and rear perspective views of a buckle retainer mounted in a cartridge housing in accordance with embodiments of the present invention.

FIGS. 6A-6B are top views bf a buckle retainer mounted in a cartridge housing in accordance with embodiments of the present invention.

FIGS. 7A-7B are cross-sectional side views of a buckle retainer mounted in a cartridge housing in accordance with embodiments of the present invention.

FIGS. 8A-8B are additional side views of a buckle retainer mounted in a cartridge housing in accordance with embodiments of the present invention.

FIG. 9 is a tape library in accordance with embodiments of the present invention.

FIG. 10 is a perspective view of a buckle retainer in accordance with other embodiments of the present invention.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

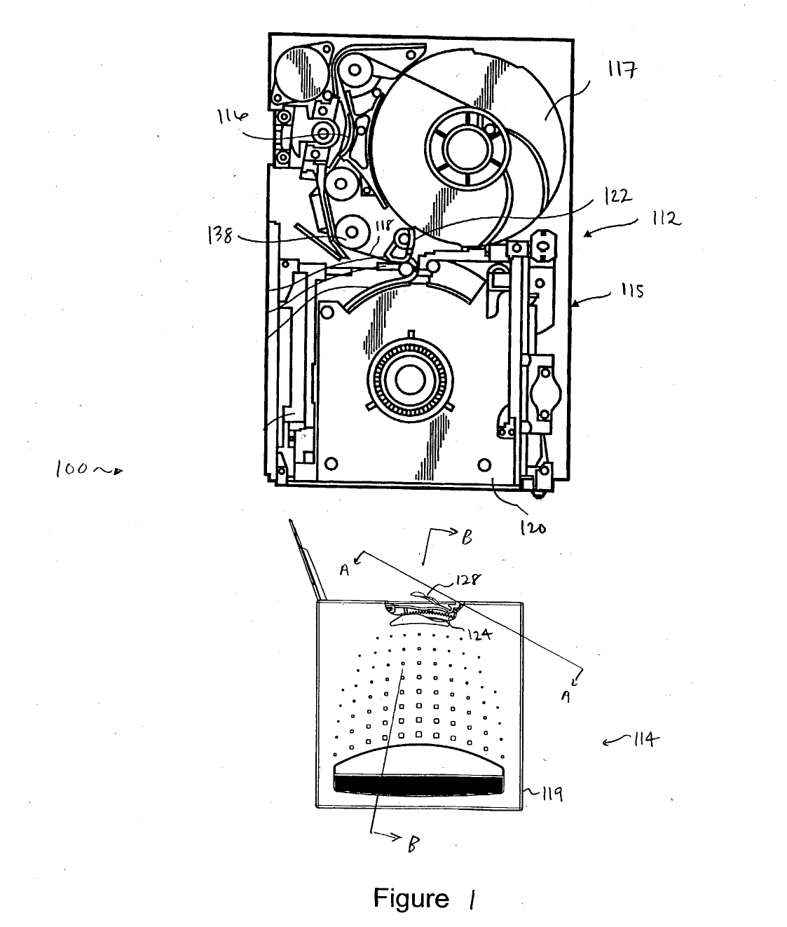

FIG. 1 shows a tape drive system 100 having a tape drive 112 and a tape cartridge 114. The tape drive 112 includes a drive housing 115, a data transducer 116, a take-up reel 117, a take-up leader 118 connected to the take-up reel 117, a tape cartridge receiver 120, and a buckling device 122. The tape cartridge 114 includes a cartridge housing 119, a cartridge reel 124, a magnetic tape 126, and a cartridge leader 128. The drive housing 115 contains the various components of the tape drive 112. The data transducer 116 transfers information to and from the storage tape 126. A plurality of tape rollers 138 can be used for guiding the storage tape 126 from the cartridge reel 124 past the data transducer 116 and onto the take-up reel 117. The tape cartridge receiver 120 is adapted to receive the cartridge 114.

In operation, the buckling device 122 couples the cartridge leader 128 on the storage tape 126 to the take-up leader 118 during loading of the tape cartridge 114 into the tape drive 112. The process of connecting the take-up leader 118 with the cartridge leader 128 is commonly referred to as “coupling” or “buckling”. Subsequently, during ejection of the tape cartridge 114, the buckling device 122 unbuckles the cartridge leader 128 from the take-up leader 118.

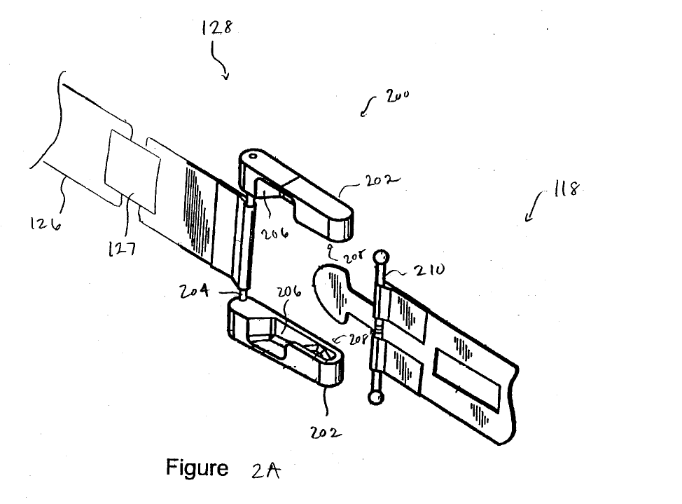

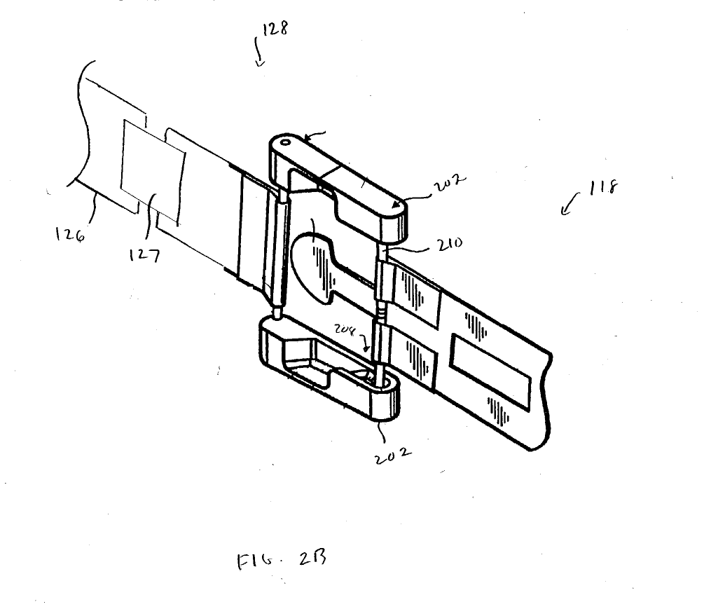

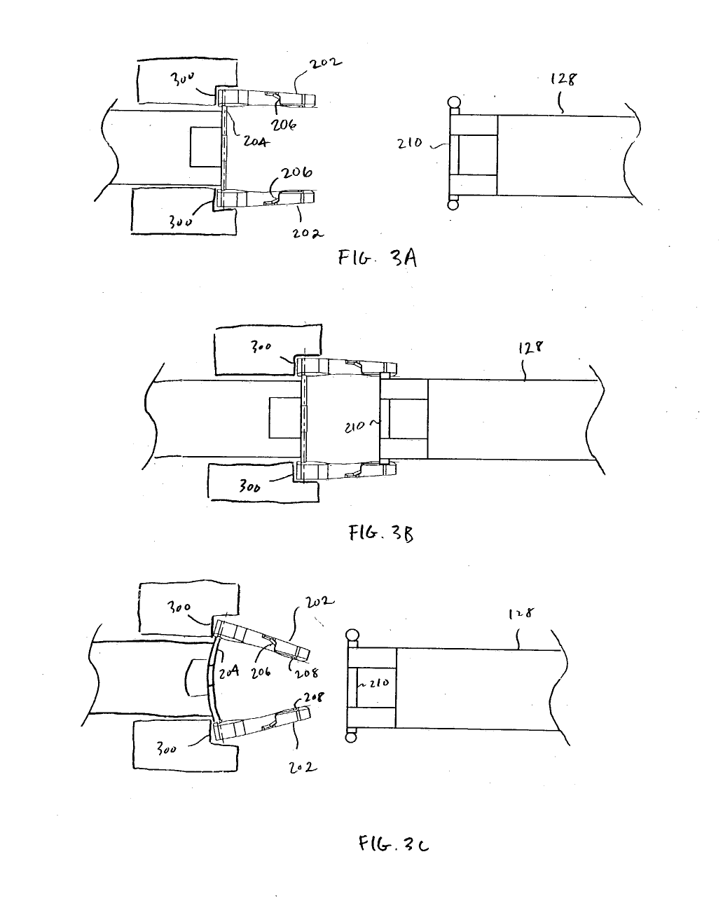

FIG. 2A is a close-up view of an exemplary cartridge leader 128 uncoupled from a take-up leader 118. FIG. 2B illustrates the cartridge leader 128 coupled to the take-up leader 118. The tape cartridge leader 128 includes a cartridge buckle assembly 200 having a pair of receiver arms 202 mounted on distal ends of a buckle pin 204. The end of the magnetic tape 126 is attached to the tape cartridge leader 128 via splice 127. Each receiver arm 202 includes a slot 206 and the take-up leader 118 includes a leader pin 210 configured to fit into the slots 206. During the buckling process, the buckling device 122 draws the take-up leader 118 to the cartridge leader 128 and inserts the distal ends of the leader pin 210 into the slots 206 in the receiver arms 202. When the ends of the leader pin 210 reach the ends 208 of the slots 206, the take-up leader 118 is fully engaged with the cartridge leader 128. At this point, the take-up reel 117 draws the take-up leader 118 and the cartridge leader 128 through the tape drive 112 and onto the take-up reel 117. Exemplary systems incorporating a cartridge leader and take-up leader are described in greater detail in U.S. Pat. No. 5,971,310, to Saliba et al., incorporated by reference herein in its entirety.

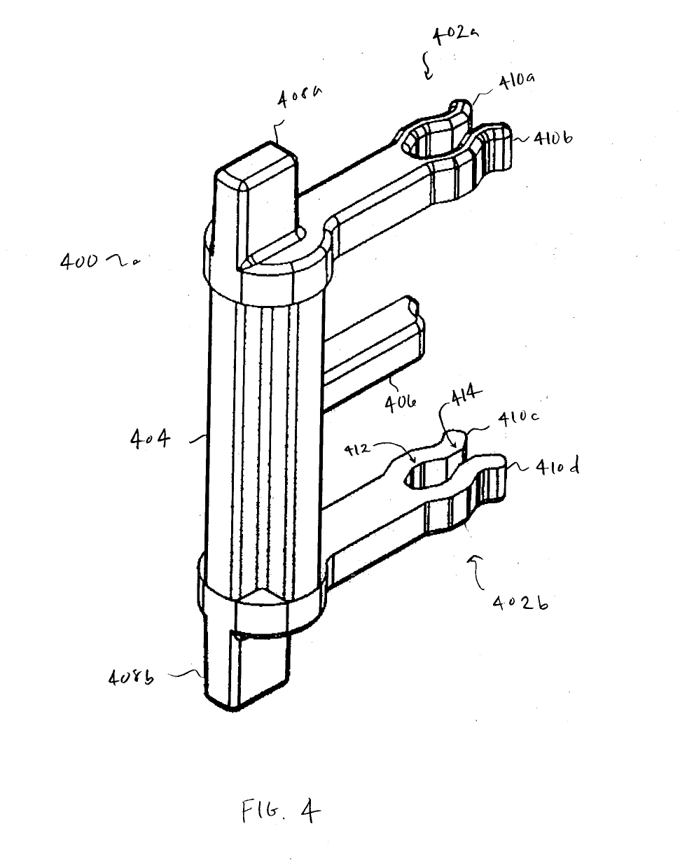

Before the tape cartridge 114 is removed from the tape drive 112, the magnetic tape 126 is rewound about the tape cartridge reel 124 and then the cartridge buckle assembly 200 is uncoupled from the take-up leader 118. During normal operation, when the magnetic tape 126 is fully rewound, the tension in the tape 126 retains the cartridge buckle assembly 200 against a pair of shoulders 300 provided in the tape cartridge housing 119, as shown in FIG. 3A. This is known as the “home” position for the cartridge buckle assembly 200. The tape cartridge 114 can then be removed and stored separately from the tape drive 112. The next time the tape cartridge 114 is inserted into the tape drive 112, the buckling device 122 is configured to try to couple the take-up leader 118 with the cartridge leader 128 assuming that the cartridge buckle assembly 200 is properly located in the home position.

In some situations, the tape cartridge 114 may be jostled or undergo some impact causing the tape cartridge reel 124 to rotate, thereby unwinding the magnetic tape 126. This may cause the cartridge buckle assembly 200 to become disengaged from the shoulders 300 and leave the home position. Then, the next time the tape drive 112 attempts to perform a buckling operation, because the cartridge buckle assembly 200 is not in the expected location, the buckling device 122 may not be capable of properly engaging the leader pin 210 with the slots 206 of the cartridge leader 128. This results in a “misbuckle,” which may prevent the tape drive 112 from loading the tape cartridge 114.

In other situations, the tape cartridge reel 124 may rotate in the opposite direction causing the magnetic tape 126 to be overwound. This may occur, for example, if too much torque is applied to the tape cartridge reel 124 during the rewind process. In this case, the cartridge buckle assembly 200 may be pressed against the shoulders 300, as shown in FIG. 3C. Here, the tension provided by the tape leader 128 onto the central portion of the buckle pin 204 is opposed by the force imparted by shoulders 300 onto the receiver arms 202, thereby causing the buckle pin 204 to bend. As a result of this bending, the distal ends of the receiver arms 202 opposite the buckle pin 204 may be drawn closer together. This effect may be referred to as “toeing in.” Accordingly, the ends 208 of the slots 206 in the receiver arms 202 are also drawn closer together.

When the receiver arms 202 are toed in, various problems may arise. The next time a buckling operation is performed, the leader pin 210 may be too wide to be fully received between the slots 206 of the compressed receiver arms 202. This may result in an immediate misbuckle error, thereby causing an interrupt in the loading operation. Even more dangerously, if the leader pin 210 is partially received into the slots 206, the buckling device 122 may not recognize that the buckling is incomplete and the tape drive 112 may continue with the winding of the magnetic tape 126 around the tape-up reel 117. When the leader pin 210 is not fully engaged with the slots 206, the take-up leader 118 may under certain circumstances become unbuckled from the cartridge leader 128 before the cartridge leader 128 has been pulled onto the take-up reel 117. This is commonly referred to as “leader runaway”. When a leader runaway occurs, the tape drive may become completely inoperable and must be manually serviced to remove the tape cartridge 114. During this time, the user cannot access to the information on the storage tape 114 and the tape drive 112 cannot be used to read any other tapes.

In accordance with aspects of the present invention, a buckle retainer is provided for releasably retaining the buckle assembly 200 when the buckle assembly 200 is not buckled with the take-up reel 117.

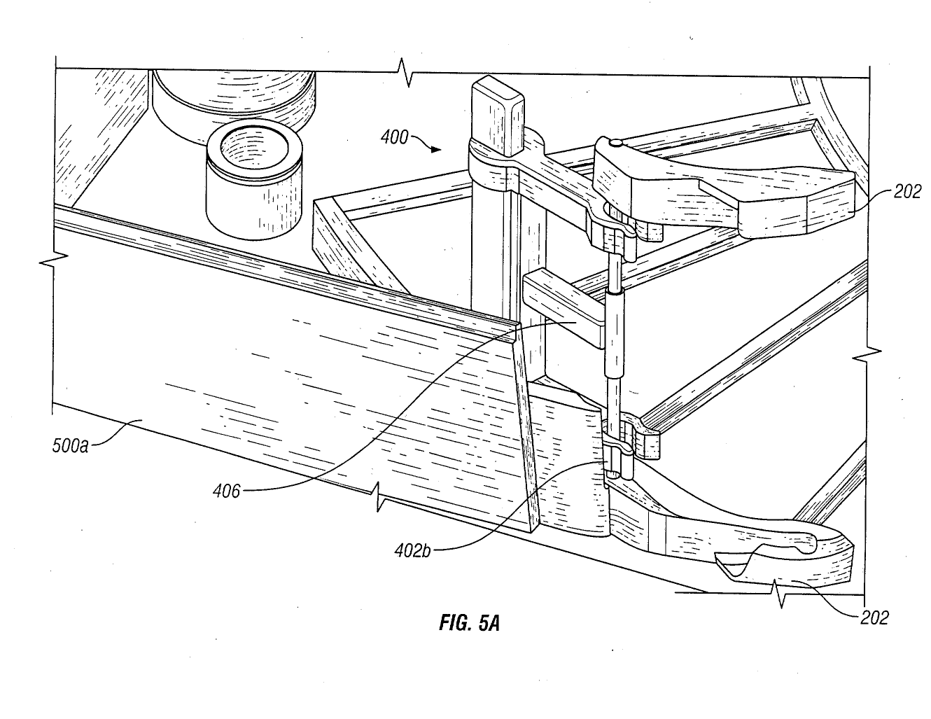

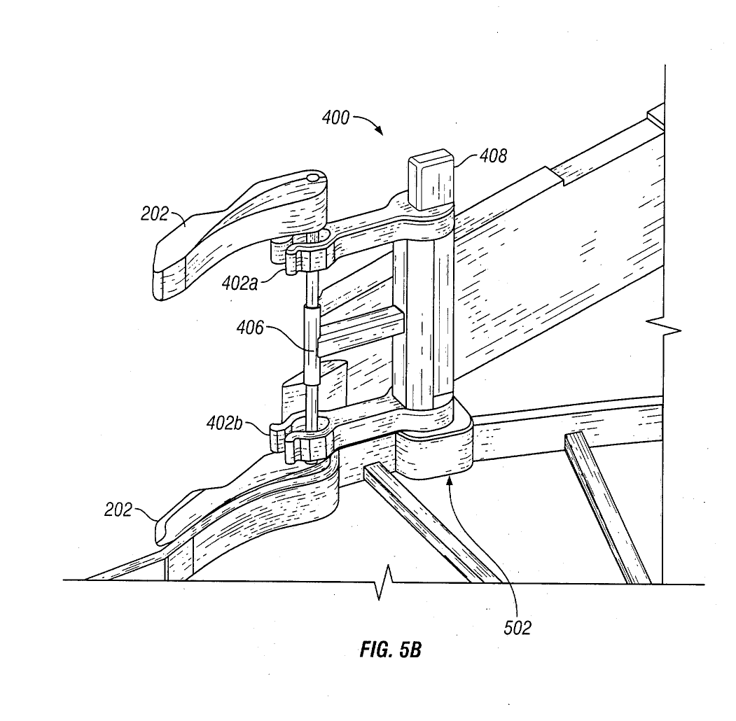

FIG. 4 is a perspective view of a buckle retainer 400, in accordance with embodiments of the present invention. The buckle retainer 400 includes a pair of clamping members 402a-402b extending from the body 404 of the retainer 400, and a pair of mounting portions 408a-408b. The mounting portions 408a-408b of the buckle retainer 400 can be used to mount the retainer 400 in the cartridge housing 119, as shown in FIGS. 5A-5B. Each of the clamping members 402a-402b include a pair of opposing flexible flanges 410a-410d. Each pair of flexible flanges 410 define a enlarged retaining region 412 for receiving a portion of the buckle assembly 200, and an opening 414 of reduced size through which the portion of the buckle assembly 200 passes as the portion is inserted into the retaining region.

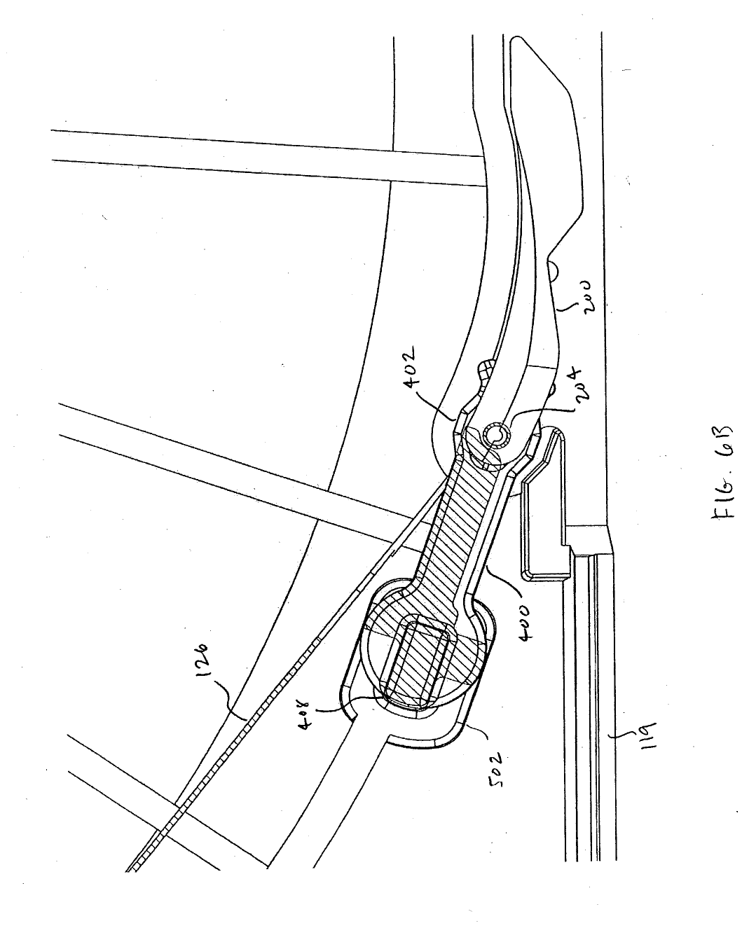

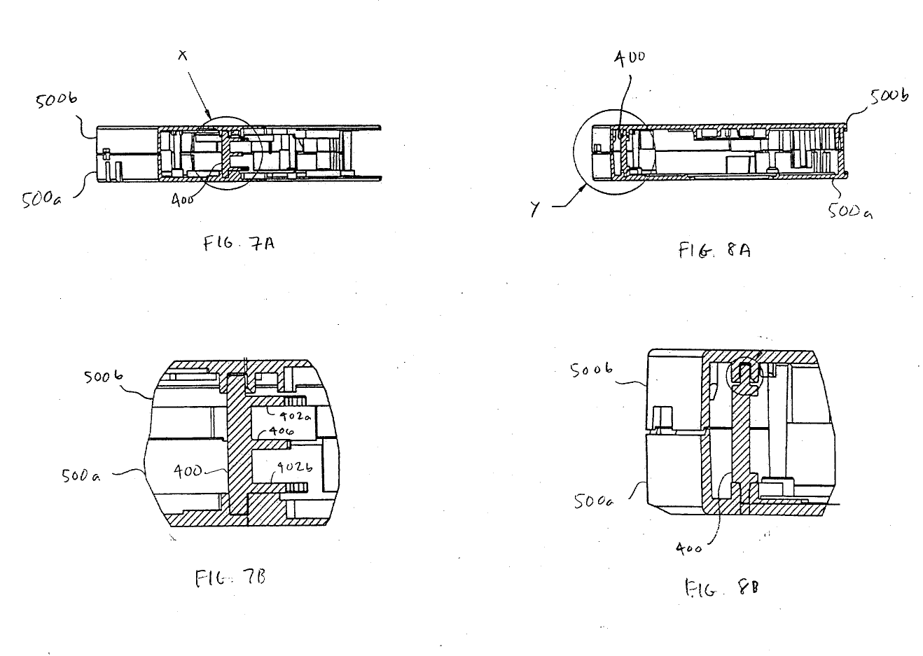

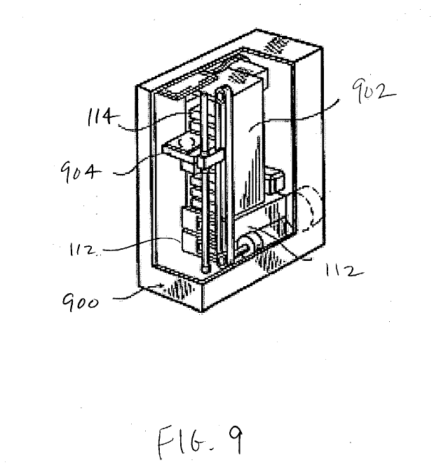

A typical tape cartridge housing 119 is formed out of a pair of top and bottom shells that are mated together with the cartridge reel 124 and magnetic tape 126 provided therebetween. FIG. 5A is a front perspective view of the buckle retainer 400 mounted in the bottom shell 500a of the tape cartridge housing 119. The top shell 500b is omitted from FIGS. 5A-5B for clarity, but is shown in FIGS. 7A-7B and 8A-8B. FIG. 5B is a rear perspective view of the buckle retainer 400 mounted in the bottom shell 500a. In FIGS. 5A-5B, the buckle assembly 200 is shown as being coupled with the buckle retainer 400, while the tape leader 128 coupled to the buckle assembly 200 is not shown for clarity. The cartridge housing 119 is configured with a pair of mounting regions (only the bottom mounting region 502 in the bottom shell 500a is shown) for mating with the mounting portions 408a-408b of the buckle retainer 400.

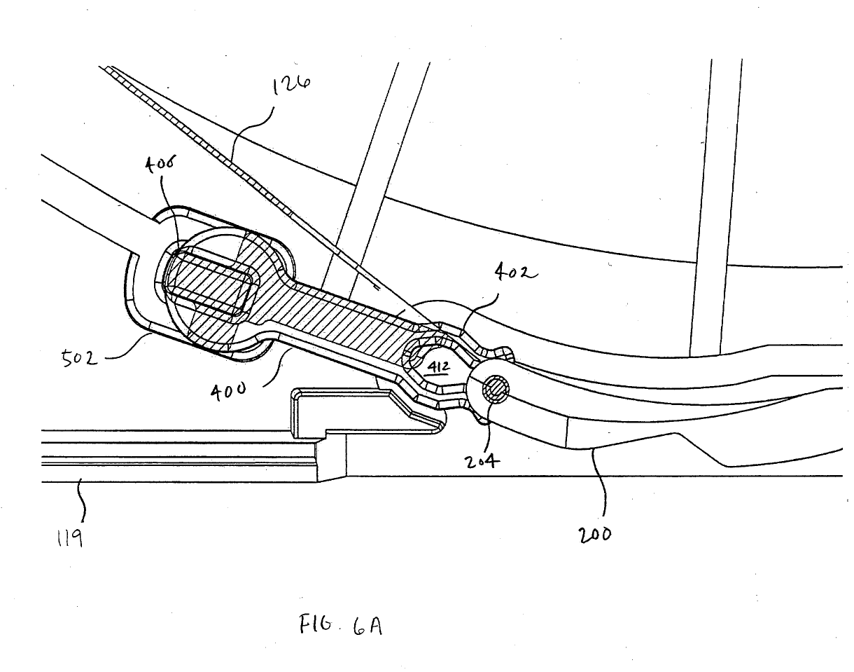

FIGS. 6A-6B are top views of the buckle retainer 400, the buckle assembly 200, and the tape leader 128. FIG. 7A is a side view of the tape cartridge 114 along line A-A in FIG. 1, and FIG. 7B is a close-up view of the region X of FIG. 7A. FIG. 8A is a side view of the tape cartridge 114 along line B-B, and FIG. 8B is a close-up view of the region Y.

In accordance with embodiments of the present invention, the buckle retainer 400 is provided for releasably retaining the cartridge buckle assembly 200. When the cartridge reel 124 is rewound, the magnetic tape 126 draws the leader buckle assembly 200 back into the tape cartridge 114, as shown in FIG. 6A. As the cartridge reel 124 continues to rotate, the buckle pin 204 is drawn into the clamping members 402a-402b, which releasably retain the buckle pin 204. In the illustrated embodiment, the clamping members 402a-402b include a pair of flexible flanges or fingers having a gap therebetween for receiving the buckle pin 204. When the buckle assembly 200 is coupled with the buckle retainer 400, the buckle pin 204 is received into the gap and is retained in place by the clamping members 402, as shown in FIGS. 5A, 5B, and 6B.

In FIG. 6A, the buckle pin 204 is located at the opening 414 between the flexible flanges 410a-410b. This opening 414 is smaller than the diameter of the buckle pin 204 and therefore provides some resistance to the buckle pin 204 as it is drawn into the retaining region 412 of the buckle retainer 400. As the magnetic tape 126 continues to apply a tension to the buckle pin 204, the flexible flanges 210a-210b flex and separate to enlarge the opening 414 to allow the buckle pin 204 to pass therethrough. Finally, the buckle pin 204 is received into the retaining region 412 and is releasably retained therein by the flexible flanges 210a-210b, as shown in FIG. 6B.

Once the buckle assembly 200 is coupled with the buckle retainer 400, tension from the tape leader 128 is not required to maintain the buckle assembly 200 in the home position. Therefore, even if the tape cartridge 114 is jarred or handled roughly causing the cartridge reel 124 to unwind, the buckle assembly 200 continues to be retained in place by the clamping members 402, despite any buildup of slack in the unwound magnetic tape 126.

The next time the tape cartridge 114 is loaded into the tape drive 112, the buckling device 122 will be able to locate the buckle assembly 200 in the expected home position. When the buckling device 122 couples the take-up leader 118 with the buckle assembly 200, the force provided by the take-up reel 117 on the take-up leader 118 is sufficient to pull the buckle pin 204 out of the clamping members 402. The buckling process can proceed as described above.

In accordance with embodiments of the present invention, the buckle retainer 400 is configured to releasably retain the buckle assembly 200. By releasably retaining the buckle assembly 200, the buckle retainer 400 provides a level of resistance to inhibit movement of the buckle assembly 200 from the home position. In the embodiment described above, the retaining force provided by the flexible flanges 410 of the clamping members 402 is sufficient to retain the buckle assembly 200 in the retaining region 412 in the event of a jarring force or other movement. However, during the buckling process, the force applied to the buckle assembly 200 by the buckling device 122 is sufficient to withdraw the buckle pin 204 from the clamping members 402. The extent of the retaining force of the buckle retainer 400 can be varied by modifying the design of the clamp depending on'the desired amount of resistance to movement.

In accordance with embodiments of the present invention, the buckle retainer 400 may further include a support 406 to inhibit bending of the buckle pin 204 when the buckle assembly 200 is coupled with the buckle retainer 400. In the illustrated embodiment, the support 406 protrudes from the body 404 of the retainer 400 at a point approximately midway between the clamping members 402a-402b and has a length such that the end of the support 406 abuts the buckle pin 204 when the buckle pin 204 is fully received in the clamping members 402a-402b.

As described above, under certain circumstances, the cartridge reel 124 may become overwound, thereby pulling the buckle assembly 200 deeper into the tape cartridge 114 beyond the home position. When the buckle assembly 200 is only supported at the distal ends of the buckle pin 204, tension from the tape leader 128 applied to the buckle pin 204 between the supporting locations may cause bending of the buckle pin 204, resulting in “toe in” of the receiver arms 202. By providing the support 406 at a location between the distal supporting locations, bending of the buckle pin 204 can be avoided.

In the illustrated embodiment, the support 406 is in the form of a protruding beam which abuts the buckle pin 204. In other embodiments, the support 406 may be formed in a variety of shapes and lengths, depending on the design of the buckle assembly 200 and the attachment of the tape leader 128 to the buckle assembly 200. In some embodiments, the support 406 may not abut the buckle pin 204 and may be separated from the pin 204 by a gap. This arrangement may be used where the buckle assembly 200 and/or the configuration of the attachment of the tape leader 128 to the buckle assembly 200 are such that a support which abuts the buckle pin 204 may be impractical, impossible, or otherwise undesirable. The gap may be sized such that a limited, acceptable amount of bending of the buckle pin 204 is permitted before the pin 204 abuts the support 406.

In the above described embodiments, the buckle retainer 400 does not include any pivoting, rotating, or movable parts, and uses only flexible flanges 410 to releasably retain the buckle assembly 200. This design is in contrast with locking mechanisms that may require hinged locks or other mechanisms which must be actuated to either retain and/or release the buckle assembly 200 from the home position. An immobile buckle retainer 400 provides the function of retaining the buckle assembly 200 using a simple, fixed component. In some embodiments, the mounting portions 408a-408b in the buckle retainer 400 may be loosely coupled to the cartridge housing 119 such that the buckle retainer 400 may change position slightly during use in order to accommodate variations in the buckling process. In these embodiments, the buckle retainer 400 may still releasably retain the buckle assembly 200 using only flexible flanges and without requiring a moving locking mechanism.

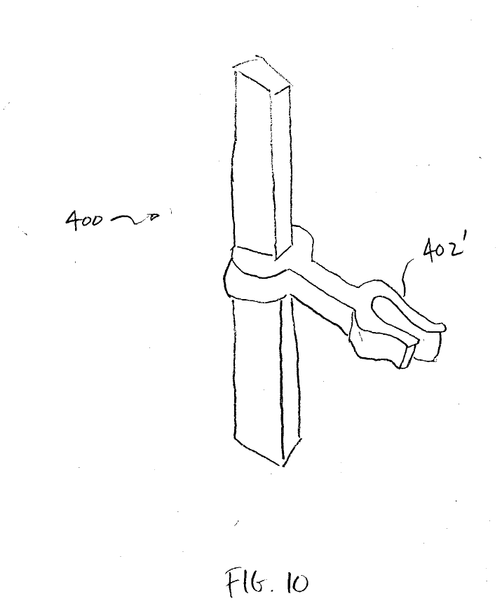

The tape drive systems 100 and tape drives 112 described above can be installed within a computer workstation or a tape library 900, as shown in FIG. 9. The illustrated tape library 900 includes a plurality of tape cartridges 114 which are retained in a multiple cartridge magazine 902, a robotic cartridge handler 904, and a pair of tape drives 112. The robotic cartridge handler 904 is used to selectively retrieve one of the tape cartridges 114 from the cartridge magazine 902 and place the tape cartridge 114 into one of the tape drives 112. A representative tape library 900 is the ATL P7000 by Quantum Corporation.

While the invention has been described in terms of particular embodiments and illustrative figures, those of ordinary skill in the art will recognize that the invention is not limited to the embodiments or figures described. For example, the buckle retainer 400 described above is formed as a separate component that is mounted into the cartridge housing 119. Because the buckle retainer 400 is formed as a separate component, the retainer 400 can be manufactured using different materials and/or manufacturing processes than the cartridge housing 119. This can facilitate the formation of fine, precise features on the buckle retainer 400. In other embodiments, the buckle retainer can be integrally formed with the housing. In one embodiment, both the buckle retainer 400 and the cartridge housing 119 are separately formed of plastic by injection molding. The buckle retainer 400 is then retained between the two clamped halves forming the cartridge housing 119. In other embodiments, the cartridge housing 119 can be made of injection molded plastic, while the buckle retainer 400 can be made of, for example, steel or machined metal.

In the illustrated embodiments, the buckle pin 204 is a roughly cylindrical stainless steel pin connecting the two retaining arms 202. In other embodiments, the buckle pin 204 need not be in the shape of a pin. For example, the buckle pin may be formed as a rectangular member connecting the two retaining arms.

In the embodiments described above, the buckle retainer 400 includes a pair of clamping member 402a-402b, which engage the buckle pin 204 near the distal ends of the buckle pin 204. In other embodiments, the buckle assembly 200 may be releasably retained by the buckle retainer using a different configuration. In the embodiment illustrated in FIG. 10, for example, a single clamping member 402′ may be provided for clamping the buckle pin 204. In some embodiments, shoulders 300, as shown in FIGS. 3A-3B, may be used to abut the ends of the buckle assembly 200 and the single clamping member 402′ may be provided midway between the shoulders 300. Accordingly, the single clamping member 402′ may simultaneously provide the functions of releasably retaining the buckle assembly 200 and inhibiting bending of the buckle pin 204. In yet other embodiments, the clamping member 402′ may include only a single flexible flange for releasably retaining the buckle assembly 200. This may be implemented by using a single flexible flange works in conjunction with a stationary, inflexible member to provide a compressive retaining force on the buckle assembly 200.

In addition, the methods and steps described above indicate certain events occurring in a certain order. Those of ordinary skill in the art will recognize that the ordering of certain steps may be modified, and that such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is thus to be regarded as illustrative instead of limiting on the invention.

1. A tape cartridge system, comprising:
a cartridge housing;
a reel provided in the cartridge housing;
a magnetic tape wound about the reel;
a cartridge buckle assembly provided at one end of the magnetic tape; and
a buckle retainer provided in the cartridge housing having at least one clamping member for releasably retaining the cartridge buckle assembly.

2. The tape cartridge system of claim 1, wherein:
said clamping member comprises at least one flexible flange for clamping the cartridge buckle assembly.

3. The tape cartridge system of claim 2, wherein:
said cartridge buckle assembly comprises a buckle pin; and
said at least one flexible flange is configured to releasably retain the buckle pin.

4. The tape cartridge system of claim 2, wherein:
said clamping member comprises two flexible flanges for clamping a portion of the cartridge buckle assembly in a retaining region between the two flexible flanges, said two flexible flanges defining an opening smaller than the portion of the cartridge buckle assembly and configured to flex so as to expand the opening to receive the portion of the cartridge buckle assembly into the retaining region.

5. The tape cartridge system of claim 4, wherein:
said cartridge buckle assembly comprises a buckle pin; and
said two flexible flanges are configured to clamp the buckle pin in the retaining region.

6. The tape cartridge system of claim 3, wherein:
said buckle pin comprises two distal end portions and a central portion between the two distal end portions; and
said clamping member is configured to releasably retain the central portion of the buckle pin.

7. The tape cartridge of claim 6, wherein:
said clamping member is configured to inhibit bending of the buckle pin.

8. The tape cartridge system of claim 3, wherein:
said at least one clamping member comprises a first clamping member and a second clamping member for releasably retaining the buckle pin, each clamping member having at least one flexible flange for clamping the buckle pin.

9. The tape cartridge system of clam 8, wherein:
said buckle retainer further comprises a support provided between the first and second clamping members, said support configured to inhibit bending of the buckle pin when the cartridge buckle assembly is retained by the first and second clamping members.

10. The tape cartridge system of claim 8, wherein:
said cartridge buckle assembly further comprises first and second arms provided at distal ends of the buckle pin for coupling with a take-up leader.

11. The tape cartridge system of claim 10, wherein:
said take-up leader includes a drive pin; and
said first and second arms include receiving portions for receiving the drive pin.

12. The tape cartridge system of claim 1, further comprising:
a tape drive including:
a take-up reel; and
a take-up leader coupled to the take-up reel, said take-up leader being configured to couple with the cartridge buckle assembly.

13. The tape cartridge system of claim 12, further comprising:
a tape cartridge magazine configured to retain a plurality of tape cartridges; and
a cartridge handler for retrieving the tape cartridges from the cartridge magazine and loading the tape cartridges into the tape drive.

14. The tape cartridge system of claim 1, wherein:
said buckle retainer is integrally formed with the cartridge housing.

15. The tape cartridge system of claim 1, wherein:
said cartridge housing includes mounting regions; and
said buckle retainer includes mounting portions engaging the mounting regions of the cartridge housing.

16. A method of operating a tape cartridge system, comprising:
rotating a reel in a tape cartridge to wind a magnetic tape around the reel until a cartridge buckle assembly provided at one end of the magnetic tape contacts a buckle retainer provided in the tape cartridge; and
coupling the cartridge buckle assembly with the buckle retainer by continuing to rotate the reel until the cartridge buckle assembly is releasably retained by the buckle retainer.

17. The method of claim 19, wherein:
said coupling the cartridge buckle assembly comprises drawing the cartridge buckle assembly into a clamping member provided in the buckle retainer.

18. The method of claim 17, wherein:
said drawing the cartridge buckle assembly into the clamp comprises drawing a buckle pin provided in the cartridge buckle assembly into the clamping member.

19. The method of claim 18, wherein:
said drawing the cartridge buckle assembly into the clamping member comprises drawing a buckle pin provided in the cartridge buckle assembly into a pair of flexible flanges.

20. The method of claim 19, further comprising:
supporting a portion of the buckle pin not retained by the pair of flexible flanges to inhibit bending of the buckle pin.

21. A buckle retainer for use in a tape cartridge having a housing, a magnetic tape wound about a cartridge reel provided in the cartridge housing, and a cartridge buckle assembly provided at one end of the magnetic tape, said buckle retainer comprising:
a mounting portion for mounting the buckle retainer in the cartridge housing; and
a clamping member having at least one flexible flange for releasably retaining the cartridge buckle assembly.

22. The buckle retainer of claim 21, further comprising:
a supporting member configured to inhibit bending of the cartridge buckle assembly.

23. The buckle retainer of claim 21, wherein:
said clamping member is configured to releasably retain a buckle pin of the cartridge buckle assembly.

24. The buckle retainer of claim 23, wherein:
said clamping portion comprises two flexible flanges for releasably retaining the buckle pin of the cartridge buckle assembly in a retaining region between the two flexible flanges.

25. The buckle retainer of claim 24, wherein:
said two flexible flanges define an opening smaller than the portion of the cartridge buckle assembly and are configured to flex so as to expand the opening to receive the buckle pin of the cartridge buckle assembly into the retaining region.

26. The buckle retainer of claim 24, further comprising:
a supporting member configured to inhibit bending of the buckle pin.

27. The buckle retainer of claim 26, wherein:
said supporting member comprises a projection positioned between the pair of flexible flanges to abut the buckle pin when the buckle pin is releasably retained by the clamping members.
